(19) United States
(12) Patent Application Publication
(10) Pub. No.: US 2026/0302501 A1
(43) Pub. Date: Oct. 1, 2026

(54) ELECTRODE STACK STRUCTURE, SECONDARY BATTERY, AND METHOD FOR MANUFACTURING SECONDARY BATTERY

(71) Applicant: HONDA MOTOR CO., LTD., Tokyo (JP)

(72) Inventors: Kizashi IWAKIRI, Saitama (JP); Fumikazu NAKAZAWA, Saitama (JP); Masahiro HOKAZONO, Saitama (JP)

(21) Appl. No.: 19/578,878

(22) Filed: Mar. 26, 2026

(30) Foreign Application Priority Data
Mar. 31, 2025 (JP) 2025-060158

(51) Int. Cl. H01M 50/293; H01M 50/291

(52) U.S. Cl. CPC H01M 50/293; H01M 50/291

(57) ABSTRACT

An electrode stack structure according to one embodiment of the present invention includes an electrode stack in which a plurality of electrode assemblies each including a positive electrode layer, a negative electrode layer, and an electrolyte layer disposed between the positive electrode layer and the negative electrode layer are stacked, and an elastic member that covers at least one side surface of the electrode stack. The elastic member has a convex shape which protrudes outward and in which a thickness of a center covering portion that covers a center portion of the electrode stack in the stacking direction is thicker than a thickness of an end covering portion that covers an end portion of the electrode stack in the stacking direction, and the thickness of the center covering portion with respect to the thickness of the end covering portion falls within the range of 1.1 or more and 10.0 or less.

This application is based on and claims the benefit of priority from Japanese Patent Application No. 2025-060158, filed on 31 Mar. 2025, the content of which is incorporated herein by reference.

### BACKGROUND OF THE INVENTION

### Field of the Invention

The present invention relates to an electrode stack structure, a secondary battery, and a method for manufacturing a secondary battery.

### Related Art

In recent years, research and development of secondary batteries that contribute to energy efficiency has been carried out in order to ensure many people have access to affordable, reliable, sustainable, and advanced energy. Among secondary batteries, all-solid-state batteries that include a solid electrolyte layer as an electrolyte have attracted attention due to their superior safety.

As an all-solid-state battery, a stack-type all-solid-state battery is known in which a plurality of electrode assemblies each including a positive electrode layer, a negative electrode layer, and a solid electrolyte layer disposed between the positive electrode layer and the negative electrode layer are stacked to form an electrode stack, and the electrode stack is housed in an exterior housing body. In this stack-type all-solid-state battery, side surfaces of the electrode stack are covered and sealed with a resin (for example, Patent Document 1). It has been studied to provide a gap between a side surface of a negative electrode active material layer and a covering resin in order to reduce cracking in the covering resin due to changes in the electrode stack (see Patent Document 2).

Patent Document 1: Japanese Unexamined Patent Application, Publication No. 2020-21551

Patent Document 2: Japanese Unexamined Patent Application, Publication No. 2019-121532

### SUMMARY OF THE INVENTION

Meanwhile, one challenge for secondary batteries is achieving higher capacity. For an all-solid-state battery in which lithium is used as a charge transfer medium, the use of lithium metal or a silicon alloy as a negative electrode active material is under consideration to increase the capacity. However, a negative electrode layer including lithium metal or a silicon alloy occludes lithium, which is a charge transfer medium, during charging, to thereby increase in thickness, and releases lithium during discharging to thereby decrease in thickness. When an amount of change in the thickness of the electrode stack increases during charging and discharging, the increase in thickness during charging causes stress between the side surfaces of the electrode stack and the covering resin, which may cause damage to the side surfaces of the electrode stack, that is, end portions of the positive electrode layers, the negative electrode layers, and the solid electrolyte layers. Providing a gap between the side surface of the negative electrode active material layer and the covering resin is effective in reducing damage to an end portion of a negative electrode layer, but it is difficult to reduce damage to end portions of the positive electrode layer and the solid electrolyte layer.

The present invention has been made in view of the above-described circumstances, and has an object to provide a secondary battery in which end portions of a positive electrode layer, a negative electrode layer, and a solid electrolyte layer are unlikely to be damaged even when a thickness of the negative electrode layer changes during charging and discharging, an electrode stack structure that can be used for the secondary battery, and a method of manufacturing a secondary battery including the electrode stack structure. This ultimately contributes to improvement in energy efficiency.
(1) An electrode stack structure including: an electrode stack in which a plurality of electrode assemblies each including a positive electrode layer, a negative electrode layer, and an electrolyte layer disposed between the positive electrode layer and the negative electrode layer are stacked; and an elastic member that covers at least one surface of a plurality of surfaces of the electrode stack, the plurality of surfaces being parallel to a stacking direction of the electrode stack, in which the elastic member has a convex shape which protrudes outward and in which a thickness of a center covering portion that covers a center portion of the electrode stack in the stacking direction is thicker than a thickness of an end covering portion that covers an end portion of the electrode stack in the stacking direction, and the thickness of the center covering portion with respect to the thickness of the end covering portion falls within the range of 1.1 or more and 10.0 or less.

According to the electrode stack structure described in (1), since the elastic member has a convex shape protruding outward, the thickness of the center covering portion with respect to the thickness of the end covering portion falls within the above-described range, and the electrode stack is covered with the elastic member having a predetermined thickness to the end portion of the electrode stack, the strength of the electrode stack is increased. Therefore, the use of the electrode stack structure described in (1) makes it possible to obtain a secondary battery in which the end portions of the positive electrode layer, the negative electrode layer, and the solid electrolyte layer are unlikely to be damaged even when the thickness of the negative electrode layer changes during charging and discharging.
(2) In the electrode stack structure described in (1), at least one surface of the plurality of surfaces of the electrode stack has a positive electrode tab extending in a direction orthogonal to the stacking direction, the at least one surface of the electrode stack from which the positive electrode tab extends or another surface different from the at least one surface has a negative electrode tab extending in a direction orthogonal to the stacking direction, and the at least one surface covered with the elastic member does not have the positive electrode tab or the negative electrode tab.

According to the electrode stack structure described in (2), the end portions of the positive electrode layer, the negative electrode layer, and the solid electrolyte layer in the surface that does not have the positive electrode tab or the negative electrode tab can be protected over a long-term period.
(3) In the electrode stack structure described in (1) or (2), a ratio of the thickness of the center covering portion to the thickness of the end covering portion falls within the range of 1.1 or more and 5.0 or less.

According to the electrode stack structure described in (3), since the thickness of the center covering portion to the thickness of the end covering portion falls within the above-described range, the strength of the electrode stack is reliably increased.
(4) In the electrode stack structure described in (1) or (2), the thickness of the end covering portion falls within the range of 0.05 mm or more and 0.20 mm or less, and the thickness of the center covering portion falls within the range of 0.1 mm or more and 1.0 mm or less.

According to the electrode stack structure described in (4), since the thickness of the end covering portion and the thickness of the center covering portion fall within the above-described respective ranges, the strength of the electrode stack is more reliably increased.
(5) A secondary battery including: the electrode stack structure described in any one of (1) to (4); and an exterior housing body that encloses the electrode stack structure, in which at least a part of the exterior housing body located at a position facing the at least one surface of the electrode stack structure covered with the elastic member is in contact with the elastic member.

According to the secondary battery described in (5), since the above-described electrode stack structure is enclosed, the end portions of the positive electrode layer, the negative electrode layer, and the solid electrolyte layer are unlikely to be damaged even when the thickness of the negative electrode layer changes during charging and discharging.
(6) In the secondary battery described in (5), the exterior housing body has an extra portion curved in the stacking direction of the electrode stack.

According to the secondary battery described in (6), since the exterior housing body has the extra portion, and the exterior housing body expands and contracts due to the extra portion when the thickness of the negative electrode layer changes during charging and discharging, the pressure applied to the electrode stack enclosed in the exterior housing body is reduced. Therefore, the end portions of the positive electrode layer, the negative electrode layer, and the solid electrolyte layer are further unlikely to be damaged even when the thickness of the negative electrode layer changes during charging and discharging.
(7) In the secondary battery described in (6), the extra portion is disposed at a position facing an end portion of the electrode stack in the stacking direction.

According to the secondary battery described in (7), since the extra portion is disposed at the above-described position, the pressure applied to the electrode stack is further reduced when the thickness of the negative electrode layer changes during charging and discharging.
(8) In the secondary battery described in any one of (5) to (7), a thickness of the negative electrode layer of the electrode stack changes during charging and discharging.

According to the secondary battery described in (8), since the thickness of the negative electrode layer changes during charging and discharging, the charging and discharging capacity is increased.
(9) In the secondary battery described in any one of (5) to (8), the center covering portion of the elastic member is compressed, via the exterior housing body, in a direction orthogonal to the surface covered with the elastic member.

According to the secondary battery described in (9), since the pressure applied to the exterior housing body is absorbed by the center covering portion, and the pressure transmitted to the end covering portion is reduced, the end portions of the positive electrode layer, the negative electrode layer, and the solid electrolyte layer are further unlikely to be damaged even when the thickness of the negative electrode layer changes during charging and discharging.
(10) In the secondary battery described in any one of (5) to (9), the exterior housing body is formed of a laminate film.

According to the secondary battery described in (10), since the exterior housing body is formed of a laminate film, the exterior housing body easily expands and contracts when the thickness of the negative electrode layer changes during charging and discharging, thereby more reliably reducing the likelihood of damage to the end portions of the positive electrode layer, the negative electrode layer, and the solid electrolyte layer.
(11) In the secondary battery described in (10), the exterior housing body includes a housing part in which the electrode stack is housed, and a sealing part by which the housing part is sealed, and the sealing part has a folding-back portion, a first region extending toward one side in the stacking direction of the electrode stack, and a second region extending from an end portion on the one side of the first region toward the other side opposite to the one side.

According to the secondary battery described in (11), since the sealing part of the exterior housing body is long, the sealing part of the exterior housing body is unlikely to rupture.
(12) A method of manufacturing a secondary battery, the method including: preparing the electrode stack structure described in any one of (1) to (4); housing the electrode stack in an exterior housing body; and pressing an outer surface of the exterior housing body facing an end surface of the electrode stack structure covered with the elastic member to bring at least a part of the elastic member into contact with the exterior housing body.

According to the method of manufacturing a secondary battery described in (12), since at least a part of the elastic member of the electrode stack structure is brought into contact with the exterior housing body using the above-described electrode stack structure, a secondary battery in which the end portions of the positive electrode layer, the negative electrode layer, and the solid electrolyte layer are unlikely to be damaged even when the thickness of the negative electrode layer changes during charging and discharging can be industrially advantageously manufactured.

According to the present invention, a secondary battery in which end portions of a positive electrode layer, a negative electrode layer, and a solid electrolyte layer are unlikely to be damaged even when a thickness of the negative electrode layer changes during charging and discharging, an electrode stack structure that can be used for the secondary battery, and a method of manufacturing a secondary battery including the electrode stack structure can be provided.

### BRIEF DESCRIPTION OF THE DRAWINGS

FIG. 1 is a plan view illustrating a secondary battery according to one embodiment of the present invention;

FIG. 2 is a cross-sectional view taken along a line II-II in FIG. 1;

FIG. 3 is a cross-sectional view of one example of an electrode stack for use in the secondary battery according to one embodiment of the present invention;

FIG. 4 is a cross-sectional view illustrating a main portion of an electrode stack structure according to one embodiment of the present invention;

FIG. 5 is a cross-sectional view illustrating a housing process included in a method of manufacturing a secondary battery according to one embodiment of the present invention;

FIG. 6 is a cross-sectional view illustrating a pressing process included in the method of manufacturing a secondary battery according to one embodiment of the present invention;

FIG. 7 is a cross-sectional view illustrating a modification of the secondary battery according to one embodiment of the present invention; and

FIG. 8 is a graph showing a relationship between a displacement amount of a root position of a joining portion and a load surface pressure of a joining sheet, the displacement amount and the load surface pressure being measured in each of Examples 1 and 2, and Comparative Example 1.

### DETAILED DESCRIPTION OF THE INVENTION

Hereinafter, an embodiment of the present invention will be described with reference to the drawings. However, the following embodiment exemplifies the present invention, and the present invention is not limited to the following embodiment. Note that the X-axis, the Y-axis, and the Z-axis are mutually orthogonal relationships. In this specification, a direction along the X-axis may be referred to as a first direction, a direction along the Y-axis may be referred to as a second direction, and a direction along the Z-axis may be referred to as a stacking direction.

### Secondary Battery

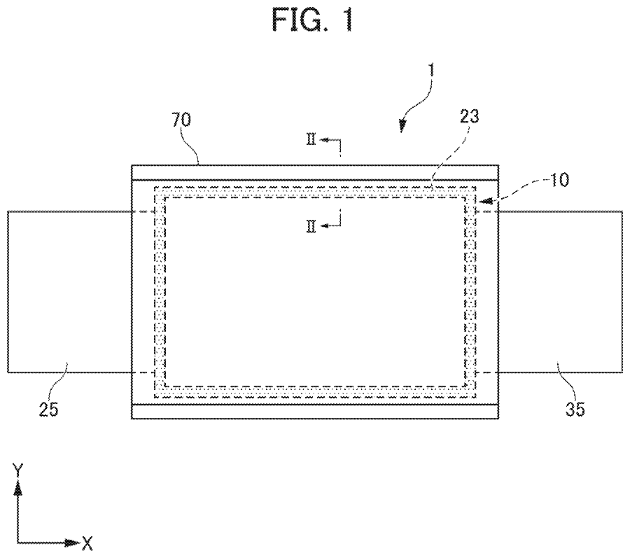

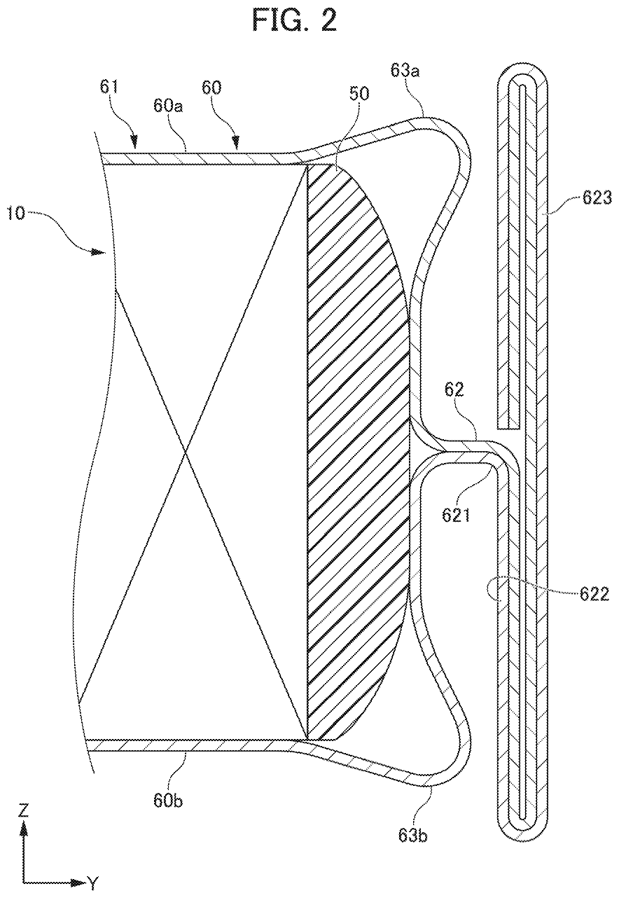

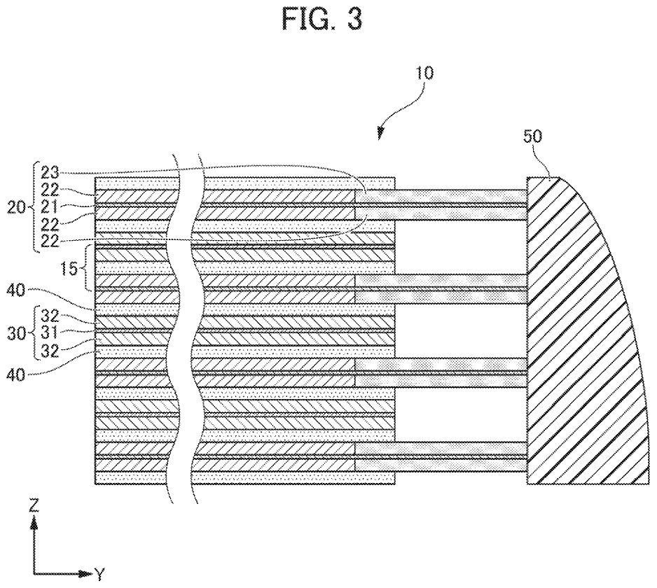

FIG. 1 is a plan view illustrating a secondary battery according to one embodiment of the present invention. FIG. 2 is a cross-sectional view taken along a line II-II in FIG. 1. FIG. 3 is a cross-sectional view of one example of an electrode stack for use in the secondary battery according to one embodiment of the present invention.

As illustrated in FIGS. 1 and 2, a secondary battery 1 includes an electrode stack 10, an elastic member 50, and an exterior housing body 60 that encloses the electrode stack 10 and the elastic member 50. The electrode stack 10 is a rectangular parallelepiped that has four surfaces parallel to the stacking direction. In this specification, a surface parallel to the stacking direction of the electrode stack 10 may be referred to as a side surface. The electrode stack 10 includes a positive electrode layer 20, a negative electrode layer 30, and a solid electrolyte layer 40. Instead of the solid electrolyte layer 40, a separator impregnated with a liquid electrolyte may be used.

As illustrated in FIG. 3, the electrode stack 10 is a stack in which a plurality of electrode assemblies 15 are stacked, the electrode assemblies 15 each including the positive electrode layer 20, the negative electrode layer 30, and the solid electrolyte layer 40 disposed between the positive electrode layer 20 and the negative electrode layer 30.

Among the lengths of the positive electrode layer 20, the negative electrode layer 30, and the solid electrolyte layer 40 in the second direction (Y-axis direction), the positive electrode layer 20 is the longest, and the negative electrode layer 30 and the solid electrolyte layer 40 have the same length in the second direction (Y-axis direction), as illustrated in FIG. 3. The length of a positive electrode active material layer 22 of the positive electrode layer 20 is shorter than the length of each of the negative electrode layer 30 and the solid electrolyte layer 40. In the second direction, an end portion of the negative electrode layer 30 is located inside end portions of the positive electrode layer 20 and the solid electrolyte layer 40. The lengths of the positive electrode layer 20, the negative electrode layer 30, and the solid electrolyte layer 40 in the second direction (Y-axis direction) are not limited thereto. For example, it is only required that the end portion of the negative electrode layer 30 is located between an end portion of the positive electrode active material layer 22 and an end portion of an insulating member 23.

The positive electrode layer 20 includes a positive electrode current collector 21, and the positive electrode active material layer 22 disposed on a surface on each side of the positive electrode current collector 21. The positive electrode current collector 21 has a positive electrode tab 25 extending toward one side of the first direction (X-axis direction) of the electrode stack 10. In a direction orthogonal to the stacking direction (Z-axis direction), the end portion of the positive electrode active material layer 22 is located inside the end portion of the positive electrode current collector 21, and the positive electrode layer 20 includes the insulating member 23 disposed on the surface of the positive electrode current collector 21 between the end portion of the positive electrode current collector 21 and an edge portion of the positive electrode active material layer 22.

The positive electrode current collector 21 is disposed in contact with the positive electrode active material layer 22, and has a function of collecting current for the positive electrode active material layer 22. The materials for the positive electrode current collector 21 may be, without particular limitation, any materials that can collect current for the positive electrode active material layer 22. Examples of the materials for the positive electrode current collector 21 include aluminum, aluminum alloys, stainless steel, nickel, iron, and titanium, and among these, at least one selected from the group consisting of aluminum, aluminum alloys, and stainless steel is preferred.

Examples of the shape of the positive electrode current collector 21 include a foil shape and a plate shape. The thickness of the positive electrode current collector 21 is not limited to a particular thickness, and may be the same as the thickness of a positive electrode used in a typical all-solid-state battery. The thickness of the positive electrode current collector 21 may be, for example, 0.1 μm or more and 1 mm or less.

The positive electrode active material layer 22 is a layer containing at least a positive electrode active material. The positive electrode active material contained in the positive electrode active material layer 22 may be, without particular limitation, any material generally used for a positive electrode active material layer in an all-solid-state battery. Examples of the positive electrode active material include a lithium-containing layered active material, a spinel active material, and an olivine active material. Specific examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), heteroelement-substituted Li-Mn spinel such as Li₁₊ₓMn_{2-x-y}M_{y}O₄ (x+y=2, and M is at least one element selected from Al, Mg, Co, Fe, Ni, and Zn), lithium titanium oxide (an oxide containing Li and Ti), and lithium metal phosphate (LiMPO₄, where M is at least one element selected from Fe, Mn, Co, and Ni).

The positive electrode active material layer 22 may optionally contain a solid electrolyte, which will be described later, in order to improve lithium ion conductivity. The positive electrode active material layer may optionally contain a binder, a conductive aid, or the like.

The thickness of the positive electrode active material layer 22 is not limited to a particular thickness, and can be appropriately set according to the desired performance of the battery. The thickness of the positive electrode active material layer may be, for example, 0.1 μm or more and 1 mm or less.

The insulating member 23 is provided at an outer edge of the positive electrode active material layer 22 in the direction orthogonal to the stacking direction. A creepage distance between the negative electrode and the positive electrode is secured by the insulating member 23, making it possible to structurally reduce short circuits of the secondary battery 1. Furthermore, this makes it possible to reduce the formation of cracks caused by changes in volume during repeated charging and discharging cycles, and to also reduce short circuits caused by cracks.

In the present embodiment, the insulating member 23 is disposed so as to cover the outer edge of each of the two positive electrode active material layers 22 formed on the respective surfaces of the positive electrode current collector 21 as illustrated in FIG. 3. The shape of the insulating member 23 may be, without particular limitation, any shape that allows the insulating member 23 to be provided at the outer edge of the positive electrode active material layer 22, and may be, for example, a frame shape. The insulating member 23 is in contact with a part of the stack surface of the positive electrode current collector 21, and may have a gap through which the positive electrode tab 25 extends.

The insulating member 23 may be constituted by any material that has insulating properties, other than semiconductors and conductors, and examples thereof include, but are not particularly limited to, an insulating oxide such as alumina, a resin such as polyvinylidene fluoride (PVDF), and rubber such as styrene-butadiene rubber (SBR).

As illustrated in FIG. 3, in the insulating member 23, the end portion in the direction orthogonal to the stacking direction is disposed outside the end portions of the negative electrode layer 30 and the solid electrolyte layer 40. That is, the insulating member 23 has a shape projecting from the stack. Accordingly, the insulating member 23 makes it possible to protect the stack from an external force, so that the safety of the secondary battery 1 can be enhanced. The elastic member 50 is disposed at the outer edge of the insulating member 23 in the second direction to secure the insulating properties of the secondary battery 1 and to further enhance the safety of the secondary battery 1 even when the insulating member 23 is damaged.

The negative electrode layer 30 includes a negative electrode current collector 31, and the negative electrode active material layer 32 disposed on a surface on each side of the negative electrode current collector 31. As described later, lithium or a lithium alloy is formed on the surface of the negative electrode active material layer 32 during charging. The negative electrode current collector 31 has a negative electrode tab 35 extending in an opposite direction to a direction in which the positive electrode tab 25 extends, of the first direction.

The negative electrode current collector 31 is disposed in contact with the negative electrode active material layer, and has a function of collecting current for the negative electrode active material layer. The materials for the negative electrode current collector may be any materials that can collect current for the negative electrode active material layer, and examples thereof include, but are not particularly limited to, metals containing at least one metallic element selected from the group consisting of silver, palladium, gold, platinum, aluminum, copper, and nickel, alloys such as stainless steel, or non-metals such as carbon (C).

The negative electrode layer 30 includes a negative electrode current collector 31, and the negative electrode active material layer 32 disposed on a surface on each side of the negative electrode current collector 31. As described later, lithium or a lithium alloy is formed on the surface of the negative electrode active material layer 32 during charging. The negative electrode current collector 31 has a negative electrode tab 35 extending in an opposite direction to a direction in which the positive electrode tab 25 extends, of the first direction.

Examples of the shape of the negative electrode current collector 31 include, but are not particularly limited to, a foil shape, a plate shape, a mesh shape, a nonwoven fabric shape, and a foamed shape. The negative electrode current collector may have a surface coated with a carbon layer, or have a surface roughened, in order to enhance adhesion with the negative electrode layer.

The thickness of the negative electrode current collector 31 is not limited to a particular thickness, and may be the same as the thickness of a negative electrode used in a typical secondary battery. The thickness of the negative electrode current collector may be, for example, 0.1 μm or more and 1 mm or less.

The negative electrode active material layer 32 is a layer containing a negative electrode active material that exchanges lithium ions and electrons. The negative electrode active material layer 32 includes lithium metal or a lithium alloy. Examples of the metal other than lithium included in the lithium alloy include tin (Sn), silver (Ag), silicon (Si), zinc (Zn), magnesium (Mg), gold (Au), platinum (Pt), palladium (Pd), aluminum (Al), bismuth (Bi), antimony (Sb), and indium (In). The lithium alloy may include one type of these metals alone, or two or more types of these metals.

The thickness of the negative electrode layer 30 is not limited to a particular thickness, and can be appropriately set according to the desired performance of the battery. The thickness of the negative electrode layer may be, for example, 0.1 μm or more and 1 mm or less.

The solid electrolyte layer 40 is disposed between the positive electrode layer 20 and the negative electrode layer 30. The solid electrolyte layer 40 includes a solid electrolyte. The material for the solid electrolyte may be, without particular limitation, any material that has ion conductivity and insulating properties. Examples of the material for the solid electrolyte include, but is not particularly limited to, inorganic solid electrolyte such as a sulfide solid electrolyte material, an oxide solid electrolyte material, a halide solid electrolyte, and a lithium-containing salt, and polymer-based solid electrolyte such as polyethylene oxide. One type of the above-described solid electrolyte materials may be used alone, or two or more types thereof may be used in combination.

The solid electrolyte layer 40 may include a binder in addition to the above-described solid electrolyte material. Examples of the binder include fluorine-based resin, a nitrile-based polymer, a polyester-based polymer, an acrylate-based polymer, a cellulose-based polymer, a styrene-based polymer, a styrene-butadiene-based polymer, a vinyl acetate-based polymer, and a urethane-based polymer. One type of the above-described binders may be used alone, or two or more types thereof may be used in combination.

In the electrode stack 10, the positive electrode active material layer 22, the negative electrode active material layer 32, and the solid electrolyte layer 40 disposed between the positive electrode active material layer 22 and the negative electrode active material layer 32 form one electrode assembly 15. The positive electrode current collector 21 connected to each electrode assembly 15 is connected to the positive electrode tab 25, and the negative electrode current collector 31 is connected to the negative electrode tab 35, so that a plurality of electrode assemblies 15 are connected in parallel.

The elastic member 50 covers a side surface (X-Z surface) intersecting the second direction (Y direction) orthogonal to the stacking direction (Z direction) of the electrode stack 10 and the first direction (X direction). The elastic member 50 may be disposed to cover the whole side surface of the electrode stack 10. Furthermore, the elastic member 50 may be disposed at a position for covering the side surface (Y-Z surface) intersecting the direction (first direction) where the positive electrode tab 25 and the negative electrode tab 35 of the electrode stack 10 are drawn out from the exterior housing body 60.

A center covering portion of the elastic member 50 is compressed in the second direction via the exterior housing body 60. The elastic member 50 may have a convex shape which protrudes outward and in which the thickness of the center portion in the stacking direction is thicker than the thickness of the end portion in the stacking direction, or may have a concave shape at the center portion in the stacking direction.

The elastic member 50 has a Young's modulus at 25° C. of 70 MPa or less. The Young's modulus at 25° C. may be 40 MPa or less. The Young's modulus at 25° C. may fall within the range of 0.1 MPa or more and 70 MPa or less, may fall within the range of 0.1 MPa or more and 40 MPa or less, or may fall within the range of 0.1 MPa or more and 5.0 MPa or less. The Young's modulus of the elastic member 50 may be 70 MPa or less, or 40 MPa or less in a temperature range of −40° C. to 100° C. When the negative electrode layer 30 of the secondary battery 1 occludes a charge transfer medium during charging, leading to an increase in thickness, and releases a charge transfer medium during discharging, leading to a decrease in thickness, the Young's modulus at 25° C. of the elastic member 50 is preferably 40 MPa or less. When an amount of change in the thickness of the negative electrode layer 30 is large during charging and discharging, the use of the elastic member 50 that has a low Young's modulus of 40 MPa and is easy to deform, thereby making it possible to further reduce the likelihood of damage to end portions of the positive electrode layer 20, the negative electrode layer 30, and the solid electrolyte layer 40.

The dielectric breakdown strength of the elastic member 50 may be, for example, 5 kV/mm or more and 50 kV/mm or less. When the temperature increases at the rate of 3° C./minute in a temperature range of 25° C. to 300° C. in the TG-DTA, the reduction rate of the weight at the temperature 200° C. with respect to the weight at the temperature 25° C. of the elastic member 50 may be 10% or less. When the temperature increases at the rate of 3° C./minute in a temperature range of 25° C. to 300° C. in the TG-DTA, the reduction rate of the weight at the temperature 200° C. with respect to the weight at the temperature 25° C. of a mixture including the elastic member 50 and the solid electrolyte contained in the solid electrolyte layer 40 at the weight ratio of 1:1 may be 10% or less.

The exterior housing body 60 houses the electrode stack 10 in a sealed state. The exterior housing body 60 includes two laminate films 60a and 60b. The exterior housing body 60 has a housing part 61 that houses the electrode stack 10, and a sealing part 62 by which the housing part 61 is sealed. The sealing part 62 is formed by fusing the laminate films 60a and 60b together.

The exterior housing body 60 has, at corners at both ends in the stacking direction, extra portions 63a and 63b curved in an expandable and contractable manner in the stacking direction. Spaces are formed between the inner sides of the extra portions 63a and 63b and the end portions of the elastic member 50. When the thickness of the negative electrode layer 30 increases, the extra portions 63a and 63b of the exterior housing body 60 expand along with the increase in thickness.

The sealing part 62 has a first region 622 formed by bending along the stacking direction at a bending portion 621 and extending toward one side (downward in FIG. 2) in the stacking direction of the electrode stack, and a second region 623 formed by extending from an end portion on the one side of the first region 622 toward the other side (upward in FIG. 2) opposite to the one side, via a folding-back portion.

### Electrode Stack Structure

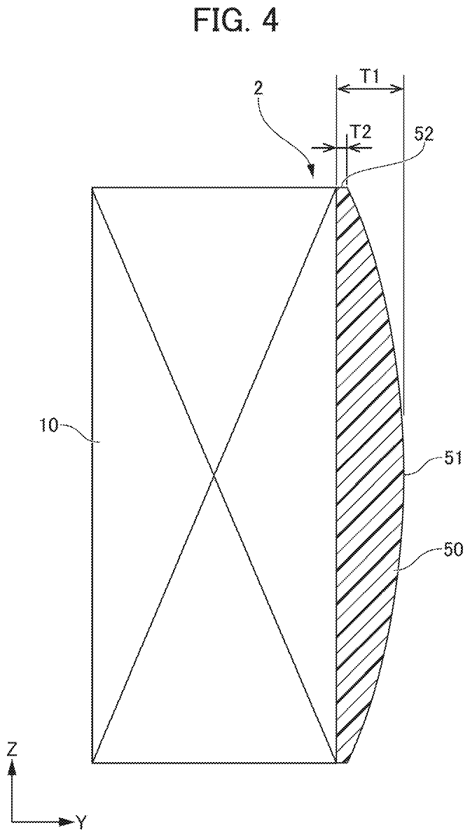

FIG. 4 is a cross-sectional view illustrating a main portion of an electrode stack structure according to one embodiment of the present invention. FIG. 4 is a cross-sectional view illustrating a side surface of the electrode stack structure, the side surface being orthogonal to the second direction (Y direction).

An electrode stack structure 2 includes the electrode stack 10, and the elastic member 50 that covers the side surface of the electrode stack 10. The elastic member 50 has a convex shape which protrudes outward and in which a thickness T1 of a center covering portion 51 that covers a center portion of the electrode stack in the stacking direction is thicker than a thickness T2 of an end covering portion 52 that covers an end portion of the electrode stack 10 in the stacking direction. The thickness T1 of the center covering portion 51 with respect to the thickness T2 of the end covering portion 52 falls within the range of 1.1 or more and 10.0 or less. The thickness T2 of the end covering portion 52 may fall within the range of 0.05 mm or more and 0.20 mm or less, for example. The thickness T1 of the center covering portion 51 may fall within the range of 0.1 mm or more and 1.0 mm or less, for example.

### Method of Manufacturing Secondary Battery

A method of manufacturing a secondary battery of one embodiment of the present invention includes a preparing process, a housing process, and a pressing process.

The preparing process is a process of preparing the electrode stack structure 2. The electrode stack structure 2 can be manufactured by forming the elastic member 50 on the surface orthogonal to the second direction of the electrode stack 10.

As a method of forming the elastic member 50, for example, a method can be used that includes applying a coating liquid containing ultraviolet-curable resin as a raw material of the elastic member 50 to the side surface intersecting the second direction of the electrode stack 10, irradiating the applied coating liquid with ultraviolet rays, and curing the ultraviolet-curable resin to form the elastic member 50.

The viscosity of the coating liquid at 25° C. may be, for example, 5 Pa·s or more and 50 Pa·s or less. The coating liquid can be applied using a well-known coating device such as a dispenser

The ultraviolet rays with which the applied coating liquid is irradiated are not limited to particular ones, but may have a wavelength within the range of 200 nm or more and 400 nm or less, or a wavelength within the range of 345 nm or more and 385 nm or less, and may have an accumulated light quantity of 21000 mj/cm² or less.

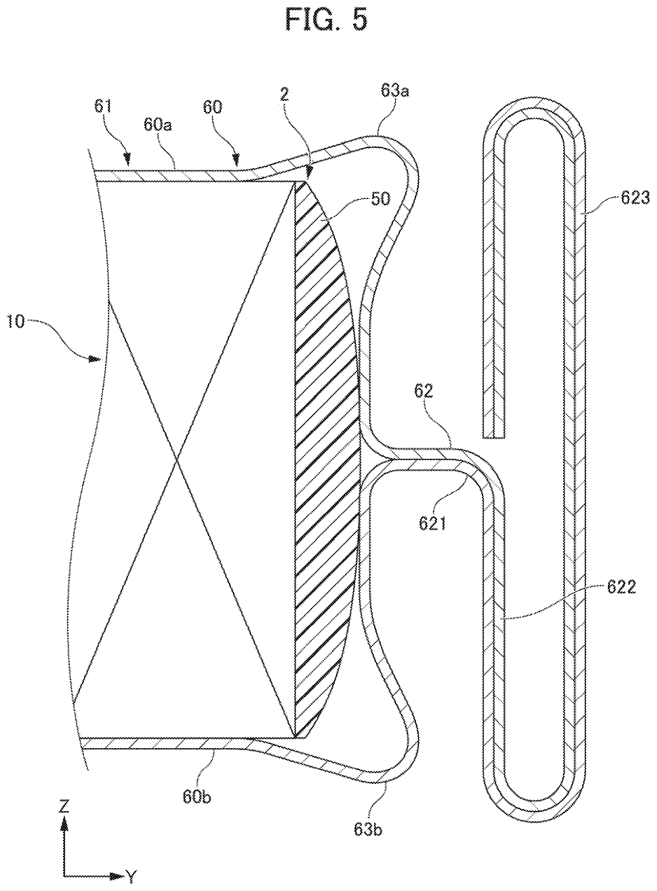

The housing process is a process of housing the electrode stack structure 2 in the exterior housing body 60, as illustrated in FIG. 5. The housing process can be performed as follows, for example. The electrode stack structure 2 is sandwiched between the two laminate films 60a and 60b. Next, the outer peripheral portions of the laminate films 60a and 60b are overlapped, and the overlapped portions are fused to form the exterior housing body 60. Subsequently, the sealing part 62 is bent in the stacking direction at the bending portion 621 to form the first region 622, and then is folded back to form the second region 623.

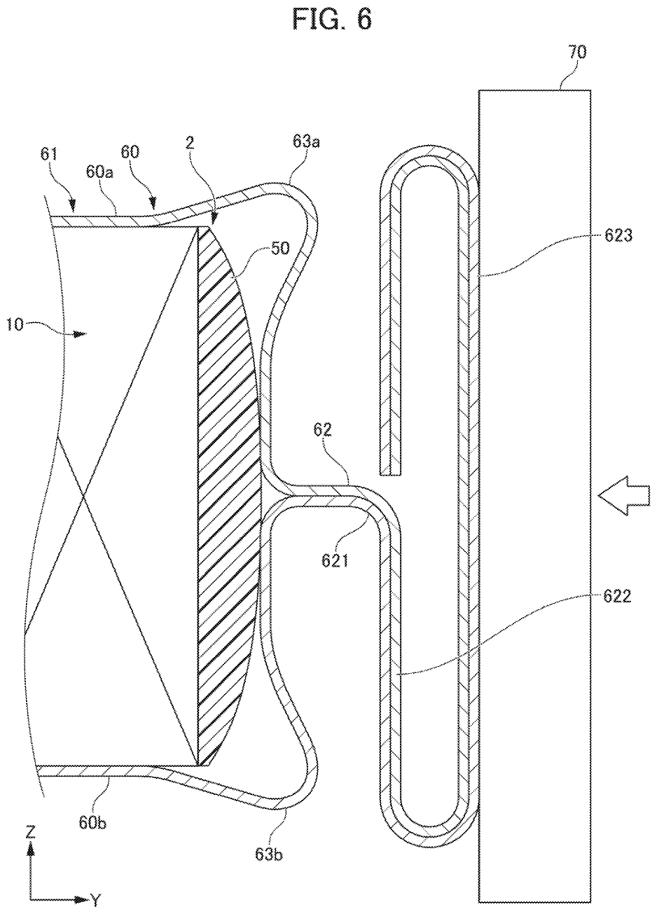

As illustrated in FIG. 6, the pressing process is a process of pressing an outer surface of the exterior housing body 60 facing an end surface of the electrode stack structure 2, the end surface being covered with the elastic member 50, using a pressing tool 70 so that at least a part of the elastic member 50 is brought into contact with the exterior housing body 60. Thus, the secondary battery 1 is manufactured.

According to the electrode stack structure 2 of the present embodiment, since the elastic member has a convex shape protruding outward, the thickness T1 of the center covering portion 51, the thickness T2 of the end covering portion 52, and a ratio (T1/T2) of the thickness T1 of the center covering portion 51 to the thickness T2 of the end covering portion 52 fall within the above-described ranges, and the electrode stack structure 2 is covered with the elastic member 50 having a predetermined thickness to the end portion of the electrode stack structure 2, the strength of the electrode stack 10 is increased. Therefore, the use of the electrode stack structure 2 of the present embodiment makes it possible to obtain the secondary battery 1 in which the end portions of the positive electrode layer 20, the negative electrode layer 30, and the solid electrolyte layer 40 are unlikely to be damaged even when the thickness of the negative electrode layer 30 changes during charging and discharging.

According to the secondary battery 1 of the present embodiment, since the above-described electrode stack structure 2 is enclosed, the end portions of the positive electrode layer 20, the negative electrode layer 30, and the solid electrolyte layer 40 are unlikely to be damaged even when the thickness of the negative electrode layer changes during charging and discharging.

According to the secondary battery 1 of the present embodiment, since the exterior housing body 60 has the extra portions 63a and 63b, and the exterior housing body 60 expands and contracts due to the deformation of the extra portions 63a and 63b when the thickness of the negative electrode layer 30 changes during charging and discharging, the pressure applied to the electrode stack 10 enclosed in the exterior housing body 60 is reduced. Therefore, the end portions of the positive electrode layer 20, the negative electrode layer 30, and the solid electrolyte layer 40 are unlikely to be damaged even when the thickness of the negative electrode layer 30 changes during charging and discharging. Furthermore, when the exterior housing body 60 is formed of the laminate films 60a and 60b, the extra portions 63a and 63b are easily deformed, thereby further reliably reducing the likelihood of damage to the end portions of the positive electrode layer 20, the negative electrode layer 30, and the solid electrolyte layer 40.

According to the secondary battery 1 of the present embodiment, since the center covering portion of the elastic member 50 is compressed in the second direction via the exterior housing body 60, the pressure applied to the exterior housing body 60 is absorbed by the center covering portion, and the pressure transmitted to the end covering portion is reduced. Therefore, the end portions of the positive electrode layer 20, the negative electrode layer 30, and the solid electrolyte layer 40 are further unlikely to be damaged even when the thickness of the negative electrode layer 30 changes during charging and discharging.

According to the secondary battery 1 of the present embodiment, the exterior housing body 60 is formed of the laminate films 60a and 60b, thereby further reliably reducing the likelihood of damage to the end portions of the positive electrode layer, the negative electrode layer, and the solid electrolyte layer.

According to the secondary battery 1 of the present embodiment, since the sealing part 62 of the exterior housing body 60 has the first region 622 and the second region 623 and thus is long, the sealing part of the exterior housing body is unlikely to rupture.

According to the method of manufacturing a secondary battery of the present embodiment, since at least a part of the elastic member 50 of the electrode stack structure 2 is brought into contact with the exterior housing body 60 using the above-described electrode stack structure 2 in the pressing process, the secondary battery 1 in which the end portions of the positive electrode layer 20, the negative electrode layer 30, and the solid electrolyte layer 40 are unlikely to be damaged even when the thickness of the negative electrode layer 30 changes during charging and discharging can be industrially advantageously manufactured.

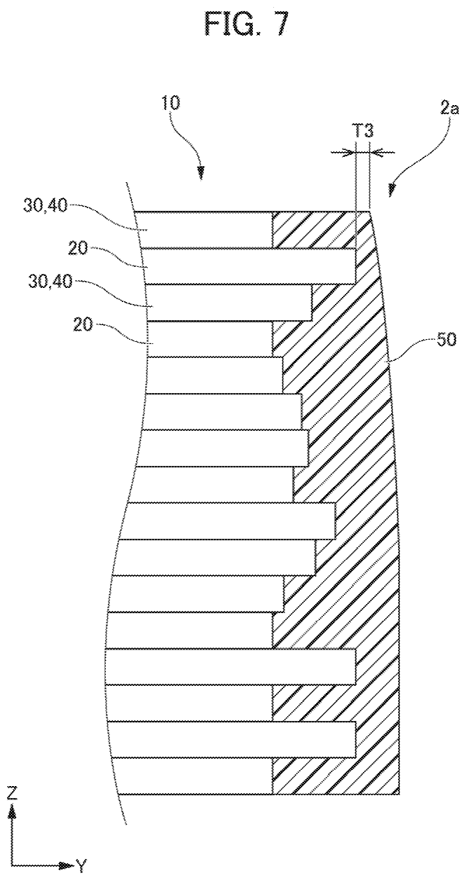

The preferred embodiment of the present invention has been described above. The present invention is not limited to the above-described embodiment, and can be modified as appropriate within a range in which the effect of the present invention is not inhibited. For example, in the present embodiment, the positions of the end portions of the positive electrode layers 20 of the electrode stack 10 are aligned, the positions of the end portions of the negative electrode layers 30 and the solid electrolyte layers 40 are aligned, but the positions of the end portions of the positive electrode layers 20, and the positions of the end portions of the negative electrode layers 30 and the solid electrolyte layers 40 are not limited thereto. An example of a secondary battery 1 in which the positions of the end portions of the positive electrode layers 20 are different from one another, and the positions of the end portions of the negative electrode layers 30 and the solid electrolyte layers 40 are different from one another is illustrated in FIG. 7.

FIG. 7 is a cross-sectional view illustrating a modification of the secondary battery according to one embodiment of the present invention. As illustrated in FIG. 7, in the secondary battery 1, the positions of the end portions of the positive electrode layers 20 are different from one another, and the positions of the end portions of the negative electrode layers 30 and the solid electrolyte layers 40 are different from one another. In this case, a thickness T3 of an end covering portion may be a thickness based on an end portion of the most projecting portion among the positive electrode layers 20, the negative electrode layers 30, and the solid electrolyte layers 40 in the electrode stack 10.

The preferred embodiment of the present invention has been described above. The present invention is not limited to the above-described embodiment, and can be modified as appropriate within a range in which the effect of the present invention is not inhibited. For example, in the present embodiment, the positive electrode tab 25 and the negative electrode tab 35 extend in the first direction (X direction) and in opposite directions from each other, but the extending method for the positive electrode tab 25 and the negative electrode tab 35 is not limited thereto. The positive electrode tab 25 and the negative electrode tab 35 may extend in the first direction (X direction) and in the same direction. Alternatively, one of the positive electrode tab 25 and the negative electrode tab 35 may extend in the first direction (X direction) and the other may extend in the second direction (Y direction). An elastic member 50 may be provided on each of surfaces from which the positive electrode tab 25 and the negative electrode tab 35 extend. Furthermore, an intermediate layer may be disposed between the negative electrode layer 30 and the solid electrolyte layer 40. When the secondary battery 1 is a lithium metal battery including lithium metal or a lithium alloy as the negative electrode active material, the intermediate layer having electron conductivity and ion conductivity can be disposed.

### EXAMPLES

Hereinafter, the present invention will be described in detail with reference to Examples. However, the present invention is not limited to the following Examples.

### Example 1

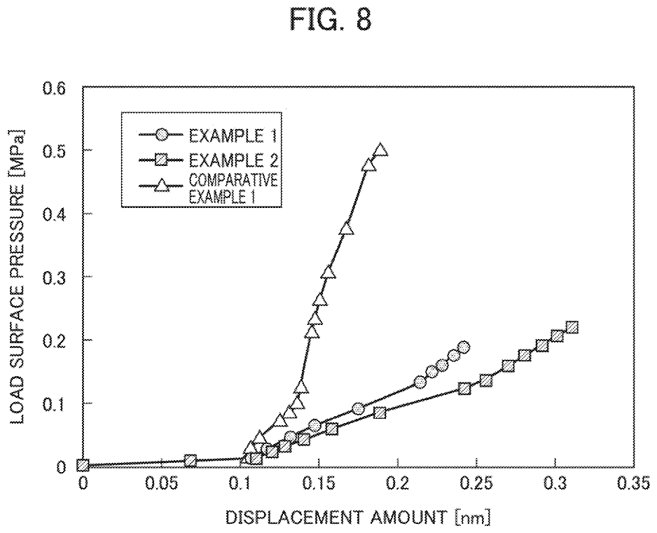

A metal aluminum block was prepared on the assumption of the electrode stack. A convex elastic resin (Young's modulus: 2.8 MPa, Poisson's ratio: 0.4) having an end portion with a thickness of 0.3 mm was formed on one surface of the metal aluminum plate. A joining sheet having a joining portion produced by joining two laminate films was prepared on the assumption of the exterior housing body. The surface of the metal aluminum block on which the convex elastic resin was formed and the joining sheet overlapped so that a distance between a center portion of the convex elastic resin and a root of the joining portion was 0.2 mm. A displacement amount of a root position of the joining portion and a load surface pressure of the joining sheet when the joining sheet was pressed against the convex elastic resin at a predetermined pressure were obtained. A relationship between the displacement amount of the root position of the joining portion and the load surface pressure of the joining sheet is shown in FIG. 8.

### Example 2

A displacement amount of a root position of the joining portion and a load surface pressure of the joining sheet was obtained in the same manner as in Example 1 except that the thickness of the end portion of the convex elastic resin was 0.5 mm. The results are shown in FIG. 8.

### Comparative Example 1

A displacement amount of a root position of the joining portion and a load surface pressure of the joining sheet was obtained in the same manner as in Example 1 except that one surface of a metal aluminum plate and a joining sheet directly overlapped without forming a convex elastic resin. The results are shown in FIG. 8.

It can be seen from the results of Examples 1 and 2 in FIG. 8 that when the convex elastic resin is formed on the side surface of the electrode stack, the pressure generated by the displacement due to deformation of the convex elastic resin is reduced when forced displacement is applied to the exterior housing body, so that the electrode stack and the exterior housing body are unlikely to be damaged. On the other hand, the results of Comparative Example 1 show that when the convex elastic resin is not formed on the side surface of the electrode stack, the root of the joining portion cannot move after coming into contact with the side surface of the electrode stack, so that further application of the forced displacement may cause damage to the joining portion.

### EXPLANATION OF REFERENCE NUMERALS

1 Secondary battery
10 Electrode stack
15 Electrode assembly
20 Positive electrode layer
21 Positive electrode current collector
22 Positive electrode active material layer
23 Insulating member
25 Positive electrode tab
30 Negative electrode layer
31 Negative electrode current collector
32 Negative electrode active material layer
35 Negative electrode tab
40 Solid electrolyte layer
50 Elastic member
60 Exterior housing body
60a, 60b Laminate film
61 Housing part
62 Sealing part
63a, 63b Extra portion

What is claimed is:

1. An electrode stack structure, comprising:
an electrode stack in which a plurality of electrode assemblies each including a positive electrode layer, a negative electrode layer, and an electrolyte layer disposed between the positive electrode layer and the negative electrode layer are stacked; and
an elastic member that covers at least one surface of a plurality of surfaces of the electrode stack, the plurality of surfaces being parallel to a stacking direction of the electrode stack, wherein
the elastic member has a convex shape which protrudes outward and in which a thickness of a center covering portion that covers a center portion of the electrode stack in the stacking direction is thicker than a thickness of an end covering portion that covers an end portion of the electrode stack in the stacking direction, and
the thickness of the center covering portion with respect to the thickness of the end covering portion falls within a range of 1.1 or more and 10.0 or less.

2. The electrode stack structure according to claim 1, wherein
at least one surface of the plurality of surfaces of the electrode stack has a positive electrode tab extending in a direction orthogonal to the stacking direction,
the at least one surface of the electrode stack from which the positive electrode tab extends or another surface different from the at least one surface has a negative electrode tab extending in a direction orthogonal to the stacking direction, and
the at least one surface covered with the elastic member does not have the positive electrode tab or the negative electrode tab.

3. The electrode stack structure according to claim 1, wherein
a ratio of the thickness of the center covering portion to the thickness of the end covering portion falls within a range of 1.1 or more and 5.0 or less.

4. The electrode stack structure according to claim 1, wherein
the thickness of the end covering portion falls within a range of 0.05 mm or more and 0.20 mm or less, and
the thickness of the center covering portion falls within a range of 0.1 mm or more and 1.0 mm or less.

5. A secondary battery, comprising:
the electrode stack structure according to claim 1; and
an exterior housing body that encloses the electrode stack structure, wherein
at least a part of the exterior housing body located at a position facing the at least one surface of the electrode stack structure covered with the elastic member is in contact with the elastic member.

6. The secondary battery according to claim 5, wherein
the exterior housing body has an extra portion curved in the stacking direction of the electrode stack.

7. The secondary battery according to claim 6, wherein
the extra portion is disposed at a position facing an end portion of the electrode stack in the stacking direction.

8. The secondary battery according to claim 5, wherein
a thickness of the negative electrode layer of the electrode stack changes during charging and discharging.

9. The secondary battery according to claim 5, wherein
the center covering portion of the elastic member is compressed, via the exterior housing body, in a direction orthogonal to the surface covered with the elastic member.

10. The secondary battery according to claim 5, wherein
the exterior housing body is formed of a laminate film.

11. The secondary battery according to claim 10, wherein
the exterior housing body includes a housing part in which the electrode stack is housed, and a sealing part by which the housing part is sealed, and
the sealing part has a folding-back portion, a first region extending toward one side in the stacking direction of the electrode stack, and a second region extending from an end portion on the one side of the first region toward the other side opposite to the one side.

12. A method of manufacturing a secondary battery, the method comprising:
preparing the electrode stack structure according to claim 1;
housing the electrode stack in an exterior housing body; and
pressing an outer surface of the exterior housing body facing an end surface of the electrode stack structure covered with the elastic member to bring at least a part of the elastic member into contact with the exterior housing body.
